(19) United States
(12) Patent Application Publication
(10) Pub. No.: US 2026/0065643 A1
(43) Pub. Date: Mar. 5, 2026

(54) DEVICE, METHOD, AND PROGRAM

(71) Applicant: Renesas Electronics Corporation, Tokyo (JP)

(72) Inventor: Yoshikazu NAGAMURA, Tokyo (JP)

(21) Appl. No.: 19/266,375

(22) Filed: Jul. 11, 2025

(30) Foreign Application Priority Data
Sep. 3, 2024 (JP) 2024-151328

(51) Int. Cl. G06V 10/764; G06T 7/00

(52) U.S. Cl. CPC G06V 10/764; G06T 7/001; G06T 2207/30148

(57) ABSTRACT

A learning support device includes: an image acquisition unit acquiring a plurality of defective circuit images representing a circuit layout causing a defect extracted from an existing circuit layout and a plurality of normal circuit images representing a normal circuit layout; a virtual image acquisition unit inputting each of the plurality of defective circuit images into a generative AI (artificial intelligence), and acquiring a plurality of virtual images generated based on the plurality of defective circuit images by using the generative AI; a learning processing unit inputting the plurality of defective circuit images, the plurality of virtual images, and the plurality of normal circuit images as training data into a classification AI; and an output unit outputting a classification AI 150 having already learned.

### CROSS-REFERENCE TO RELATED APPLICATION

The disclosure of Japanese Patent Application No. 2024-151328 filed on Sep. 3, 2024, including the specification, drawings and abstract is incorporated herein by reference in its entirety.

### BACKGROUND

The present disclosure relates to a learning support technique for a classification AI.

One of defects in a semiconductor device is a defect caused by a circuit layout. Examples of the defect caused by the circuit layout include a crystal defect that occurs on a substrate having a specific circuit layout, voids that occur in a via in a specific wiring layout and others. In order to detect the defect caused by the circuit layout, circuit layout information of the semiconductor device may be used.

There is disclosed technique listed below.
[Patent Document 1] Japanese Patent Application Laid-Open Publication No. 2007-335605

As to analysis of a defect in a semiconductor device, for example, the Patent Document 1 discloses a defect analysis apparatus for the semiconductor device. The defect analysis apparatus is made of a test information acquisition unit acquiring a defect observation image of the semiconductor device, a layout information acquisition unit acquiring layout information, and a defect analysis unit analyzing the defect. By using wiring information indicating that a configuration of a plurality of wirings in the semiconductor device is described by a pattern data group of respective wiring patterns in a plurality of layers, the defect analysis unit extracts a wiring passing through an analysis region among the plurality of wirings as a defect candidate wiring, and further extracts a candidate wiring by performing equipotential tracing of the wiring patterns using the pattern data group in the extraction of the candidate wiring (see SUMMARY).

### SUMMARY

It is difficult to previously prepare a large number of samples of the defect caused by the circuit layout. Particularly, it is difficult to prepare samples of the defect caused by the circuit layout that is less in the number of samples. Therefore, according to a technique disclosed in the Patent Document 1, the defect caused by the circuit layout that is less in the number of samples may not be detectable.

The present disclosure has been made in view of the above-described background, and may achieve easy detection of the defect caused by the circuit layout that is less in the number of samples.

Virtual images are generated based on a plurality of defective circuit images representing the circuit layout causing the defect, by using a generative AI (artificial intelligence). The virtual images are used as training data for a classification AI.

According to an embodiment, a technique according to the present disclosure achieve the easy detection of the detect caused by the circuit layout that is less in the number of samples.

Other problems and novel characteristics will be apparent from the description of the present specification and the accompanying drawings.

### BRIEF DESCRIPTIONS OF THE DRAWINGS

FIG. 1 is a diagram illustrating a first operation example of a learning support device according to the present embodiment.

FIG. 2 is a diagram illustrating a second operation example of the learning support device according to the present embodiment.

FIG. 3 is a diagram illustrating an example of a functional block configuration of a learning support device 300 according to the present embodiment.

FIG. 4 is a diagram illustrating an example of a hardware configuration of the learning support device 300 according to the present embodiment.

FIG. 5 is a diagram illustrating an example of a sample of a circuit image causing a defect.

FIG. 6 is a diagram illustrating an example of similarities among detective circuit images E1 to E7 illustrated in FIG. 5.

FIG. 7 is a diagram illustrating an example of an experimental result 700 using the defective circuit images illustrated in FIG. 5.

FIG. 8 is a diagram illustrating an example of an application using a classification AI 150.

FIG. 9 is a diagram illustrating an example of flow of processing performed by the learning support device 300 according to the present embodiment.

### DETAILED DESCRIPTION

Embodiments of a technical idea according to the present disclosure will be described below with reference to the drawings. In the following description, the same components are denoted by the same reference symbols. The same goes for names and functions of the components. Therefore, detailed descriptions thereof are not repeated. Embodiments, modification examples, software or program configurations, hardware configurations, functions, and processes, and the like may be selectively combined as appropriate.

### A. Operation and Configuration of Learning Support Device for Classification AI

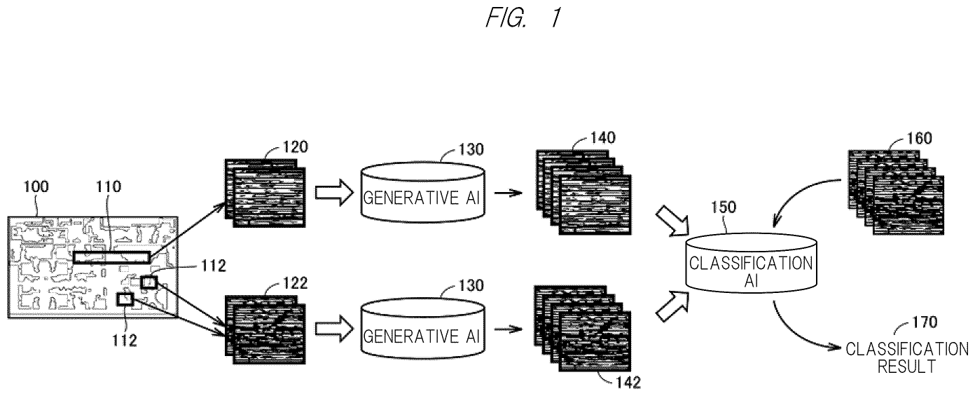

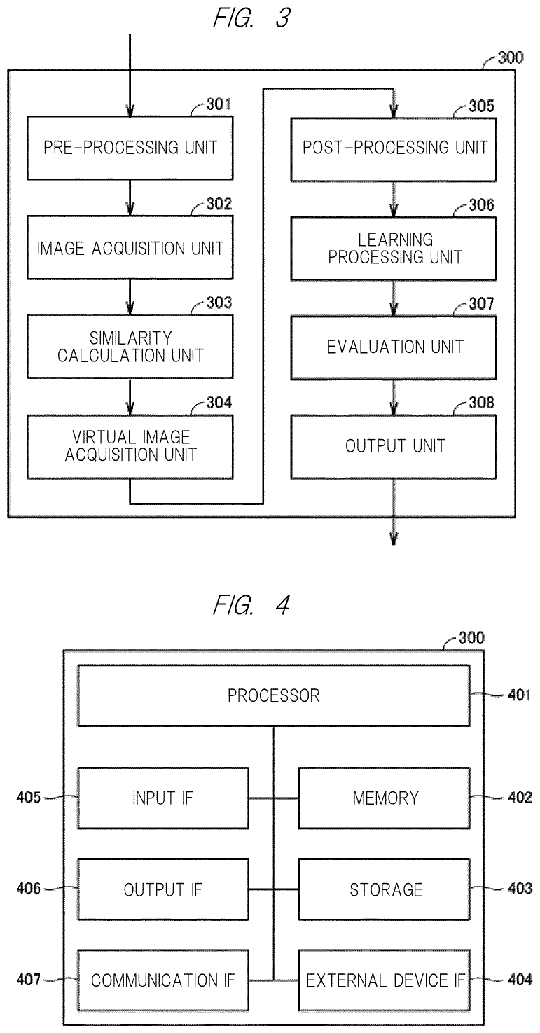

FIG. 1 is a diagram illustrating a first operation example of a learning support device according to the present embodiment. A learning support device 300 (see FIG. 3) according to the present embodiment supports learning of a classification AI 150 for detecting the detect caused by the circuit layout of the semiconductor device. Accordingly, the learning support device 300 increases the number of training data to be input into the classification AI 150 by using a generative AI 130. The training data described here is a circuit layout image of the semiconductor device 100.

In the present disclosure, the “circuit layout” refers to a wiring layout of the semiconductor device. A general semiconductor device has a multi-layer structure, and a plurality of layers included in the multi-layer structure are respectively used as wiring layers. Accordingly, the circuit layout may include a layout of two or more layer wirings. The circuit layout also includes information about a via for connecting different layer wirings. In the present disclosure, the circuit layout includes a wiring layout of the entire or a part of the semiconductor device. The circuit layout includes a wiring layout image extracted from design data of the semiconductor device and a wiring layout image obtained by capturing an image of a manufactured semiconductor device by using a camera or the like. In the present disclosure, a “circuit layout image that may cause a manufacturing defect” is also referred to as a “defective circuit image”. A “normal circuit layout image” may also be referred to as a “normal circuit image”. The defective circuit image and the normal circuit image may also be collectively referred to as a “circuit image”.

Generally, occurrence of the manufacturing defect in the semiconductor device is rare. Accordingly, it is difficult to prepare a sufficient number of the defective circuit images as training data for the classification AI 150. Therefore, the learning support device 300 acquires the defective circuit image 122 from design data of the existing semiconductor device 100 or the like. Then, the learning support device 300 generates virtual images of the defective circuit images 122 by using the generative AI 130. That is, the learning support device 300 can generate a large number of defective circuit image samples from a small number of defective circuit images 122. In this manner, the learning support device 300 can prepare the defective circuit image samples required for the training of the classification AI 150.

Then, a series of operations of the learning support device 300 will be described. First, the learning support device 300 acquires a plurality of normal circuit images 120 and a plurality of defective circuit images 122. Each of the plurality of normal circuit images 120 is an image of a part of the existing semiconductor device 100 as well as the normal part 110 having no defect. Each of the plurality of defective circuit images 122 is an image of a part of the existing semiconductor device 100 as well as a defective part 112.

In an aspect, the learning support device 300 may acquire a circuit layout image or design data of the entire existing semiconductor device 100 and position information of the defective part 112. In this case, the learning support device 300 can divide the circuit layout image into sections, and can extract a sectioned image including the defective part 112 as the defective circuit image 122. Similarly, the learning support device 300 can extract a sectioned image not including the defective part 112 as the normal circuit image 120.

Then, the learning support device 300 inputs the plurality of normal circuit images 120 into the generative AI 130. The generative AI 130 outputs a plurality of virtual images 140 based on the plurality of normal circuit images 120. For example, it is assumed that a first normal circuit image and a second normal circuit image are input into the generative AI 130. It is assumed that the generative AI 130 is set to generate 500 virtual images per image. In this case, the generative AI 130 outputs 500 virtual images of the first normal circuit image and 500 virtual images of the second normal circuit image. The learning support device 300 acquires a set of the plurality of virtual images 140 from the generative AI 130. For example, if the number of the normal circuit images 120 input into the generative AI 130 is 100, the learning support device 300 acquires 100 sets of the plurality of virtual images 140.

Similarly, the learning support device 300 inputs the plurality of defective circuit images 122 into the generative AI 130. The generative AI 130 outputs a plurality of virtual images 142 based on the plurality of defective circuit images 122. The learning support device 300 acquires a set of the plurality of virtual images 142 from the generative AI 130.

In an aspect, the generative AI 130 may generate the plurality of virtual images 142 based on the individual defective circuit image 122. For example, it is assumed that a first defective circuit image and a second defective circuit image are individually input into the generative AI 130. In this case, the generative AI 130 can generate a set of first virtual images based on the input first defective circuit image and further generate a set of second virtual images based on the input second defective circuit image. The set of first virtual images can include a feature of the first defective circuit image. The set of second virtual images can include a feature of the second defective circuit image. That is, when the generative AI 130 generates the plurality of virtual images 142 based on the individual defective circuit image 122, the learning support device 300 can acquire a set of the plurality of virtual images 140 corresponding to the plurality of defective circuit images 122, respectively. Similarly, the generative AI 130 may generate the plurality of virtual images 140 based on the individual normal circuit image 120.

In another aspect, the generative AI 130 may generate the plurality of virtual images 142 based on the plurality of defective circuit images 122. For example, it is assumed that 10 defective circuit images including a first defective circuit image to a tenth defective circuit image are input into the generative AI 130. In this case, the generative AI 130 can generate a set of a plurality of virtual images based on the input 10 defective circuit images. Each of the generated virtual images can include one or more features of the 10 defective circuit images. For example, one virtual image may include only a feature of the first defective circuit image. As another example, another virtual image may include respective features of the first defective circuit image, the second defective circuit image, and the seventh defective circuit image. That is, when the generative AI 130 generates the plurality of virtual images 142 based on the plurality of defective circuit images 122, the learning support device 300 can acquire a set of the plurality of virtual images 140 including at least one feature of the plurality of defective circuit images 122. Similarly, the generative AI 130 may generate the plurality of virtual images 140 based on the plurality of normal circuit images 120.

In an aspect, the generative AI 130 may generate virtual images such that the number of images included in the set of the plurality of virtual images 140 is equal to the number of images included in the set of the plurality of virtual images 142. In another aspect, the generative AI 130 may generate virtual images such that the total number of images included in a set of the plurality of normal circuit images 120 and the plurality of virtual images 140 is equal to the total number of images included in a set of the plurality of defective circuit images 122 and the plurality of virtual images 142.

In an aspect, the learning support device 300 may include the generative AI 130 therein. In another aspect, the learning support device 300 may use an external generative AI 130. In either circumstance, the learning support device 300 can input an optional prompt or parameter into the generative AI 130, and acquire a set of the plurality of virtual images 140 and a set of the plurality of virtual images 142 as many as desired. Examples of the parameter to be input into the generative AI 130 can include the plurality of normal circuit images 120, the plurality of defective circuit images 122, the number of the generated virtual images of each image, and other optional information.

In an aspect, the learning support device 300 may cause the generative AI 130 to previously perform the learning using the plurality of normal circuit images 120, the plurality of defective circuit images 122, or the other images. The generative AI 130 can accurately generate the virtual image of the circuit image by performing the previous learning for the circuit image.

In the example illustrated in FIG. 1, the learning support device 300 generates the plurality of virtual images 140 and the plurality of virtual images 142 by using the single generative AI 130. However, this is only an example. In an aspect, the learning support device 300 may use an individual generative AI for the generations of the plurality of virtual images 140 and generation of the plurality of virtual images 142. For example, the learning support device 300 can use a first generative AI for the generation of the plurality of virtual images 140 from the plurality of normal circuit images 120 and can use a second generative AI for the generation of the plurality of virtual images 142 from the plurality of defective circuit images 122.

Then, the learning support device 300 inputs a set of the plurality of normal circuit images 120 and the plurality of virtual images 140 and a set of the plurality of defective circuit images 122 and the plurality of virtual images 142 as training data into the classification AI 150. In an aspect, the learning support device 300 may input some of images included in the set of the plurality of normal circuit images 120 and the plurality of virtual images 140 and the set of the plurality of defective circuit images 122 and the plurality of virtual images 142 as training data into the classification AI 150. The classification AI 150 learns classification of the circuit layout based on the images input as the training data. That is, the classification AI 150 learns how to classify each of the input circuit images into either a normal circuit image or an abnormal circuit image.

Then, the learning support device 300 causes the classification AI 150 having already learned, to read a plurality of test images 160. A correct-answer classification result is associated with each of the plurality of test images 160. The classification AI 150 returns a classification result 170 of each of the plurality of test images 160 to the learning support device 300. The learning support device 300 compares the classification result 170 of each of the plurality of test images 160 with the correct-answer classification result, and verifies the classification accuracy of the classification AI 150. If a correctness rate in the classification AI 150 is equal to or more than a predetermined threshold value, the learning support device 300 outputs the classification AI 150. If the correctness rate in the classification AI 150 is less than the predetermined threshold value, the learning support device 300 causes the classification AI 150 to perform additional learning.

As described with reference to FIG. 1, the learning support device 300 utilizes the virtual images generated by the generative AI 130 as training data for the classification AI 150. In this manner, the learning support device 300 can prepare the number of defective circuit samples sufficient for the learning of the classification AI 150. As a result, the learning support device 300 can enhance the classification accuracy of the classification AI 150 for the circuit image.

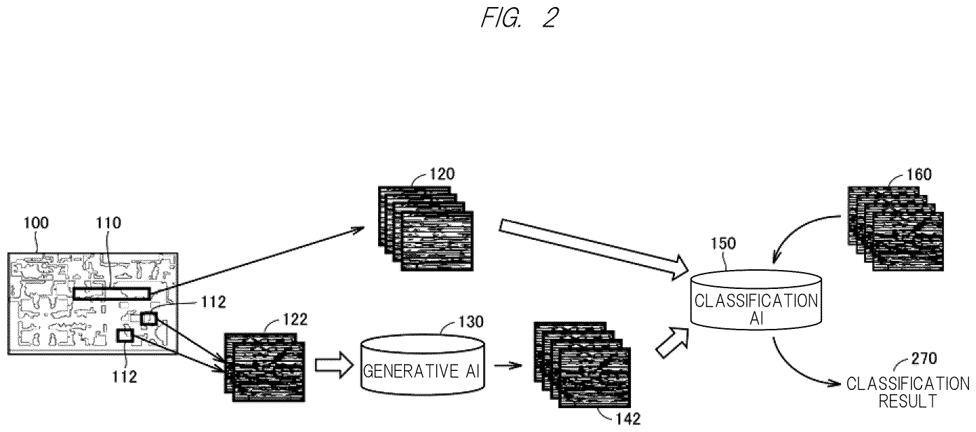

FIG. 2 is a diagram illustrating a second operation example of the learning support device according to the present embodiment. A difference between the second operation example and the first operation example will be described with reference to FIG. 2. In the second operation example, the generative AI 130 does not generate a set of the plurality of virtual images 140 from the plurality of normal circuit images 120. That is, the learning support device 300 inputs the plurality of defective circuit images 122 into the generative AI 130, but does not input the plurality of normal circuit images 120 into the generative AI 130. The generative AI 130 outputs the plurality of virtual images 142 based on the plurality of defective circuit images 122. The learning support device 300 acquires a set of the plurality of virtual images 142 from the generative AI 130.

Then, the learning support device 300 inputs a set of the plurality of normal circuit images 120, the plurality of defective circuit images 122, and the plurality of virtual images 142 as training data into the classification AI 150. The learning support device 300 can easily obtain the normal circuit images 120 from design data of the existing semiconductor device 100, design data of another semiconductor device or the like. Accordingly, the learning support device 300 may acquire the plurality of normal circuit images 120 as many as the total number of sets of the plurality of defective circuit images 122 and the plurality of virtual images 142.

Then, as similar to the first operation example, the learning support device 300 causes the classification AI 150 having already learned, to read the plurality of test images 160, and to test a classification result 270 in the learning support device 300. If the correctness rate in the classification AI 150 is equal to or more than a predetermined threshold value, the learning support device 300 outputs the classification AI 150. If the correctness rate in the classification AI 150 is less than the predetermined threshold value, the learning support device 300 causes the classification AI 150 to perform additional learning.

There is a difference in the training data input into the classification AI 150 between the first operation example and the second operation example. Accordingly, the classification result 170 and the classification result 270 may be also different. In the first operation example, the learning support device 300 can easily prepare more training data than that in the second operation example by using the generative AI 130. In the second operation example, the learning support device 300 can increase a ratio of actual circuit images occupied in the training data.

In an aspect, the learning support device 300 may be configured to select and execute the operation described in either one of the first operation example and the second operation example, based on a setting input from a user. In this case, the user can select which one of the first operation example and the second operation example is to be used, depending on, for example, the number of design data of the semiconductor device that can be prepared.

FIG. 3 is a diagram illustrating an example of a functional block configuration of the learning support device 300 according to the present embodiment. Each of functional blocks illustrated in FIG. 3 has a configuration for achieving a function of the learning support device 300 described in the present embodiment, and can be made of a program, hardware, or a combination thereof. In an aspect, each of functional blocks illustrated in FIG. 3 may be achieved by executing a program on hardware illustrated in FIG. 4. In another aspect, some of the functional blocks illustrated in FIG. 3 may be achieved as hardware. In this case, the learning support device 300 includes hardware corresponding to one or more of the functional blocks illustrated in FIG. 3 in addition to the hardware illustrated in FIG. 4.

The learning support device 300 includes a pre-processing unit 301, an image acquisition unit 302, a similarity calculation unit 303, a virtual image acquisition unit 304, a post-processing unit 305, a learning processing unit 306, an evaluation unit 307, and an output unit 308.

The pre-processing unit 301 performs an optional processing to data that has not been input into the generative AI 130. The pre-processing unit 301 outputs the processed data to the image acquisition unit 302. The data described here includes the circuit layout of the entire semiconductor device (hereinafter referred to as an “entire circuit image”), the plurality of normal circuit images, and the plurality of defective circuit images.

In an aspect, the pre-processing unit 301 can extract the normal circuit image and the defective circuit image from the entire circuit image. More specifically, the pre-processing unit 301 receives the entire circuit image and the position information of the defect part generated on the entire circuit image as its input. The pre-processing unit 301 can extract the plurality of normal circuit images and the plurality of defective circuit images from the entire circuit image for each section. The pre-processing unit 301 can extract the section including the defective generation part as the defective circuit image, and extract the other section as the normal circuit image.

In another aspect, the pre-processing unit 301 can set a coefficient or a weight for each section. The coefficient is a parameter to be input into the generative AI 130 and is used as an adjustment parameter for adjusting an amount of change of the virtual image from the original image. For example, the pre-processing unit 301 can set a first coefficient for the section including the defective part, and set a second coefficient different from the first coefficient for the section including the normal part. The pre-processing unit 301 may associate the coefficient as tag or meta data with each of the extracted normal circuit images and the extracted defective circuit images. The learning support device 300 puts the coefficients into the parameters for the generative AI 130, and thus, can individually adjust the amount of change of the virtual image in the defective circuit image from the original image and the amount of change of the virtual image in the normal circuit image from the original image. For example, the learning support device 300 can set the amount of change of the virtual image in the defective circuit image from the original image to be smaller than the amount of change of the virtual image in the normal circuit image from the original image.

In another aspect, the pre-processing unit 301 may generate a defective circuit image resulted from 90-degree rotation of each of the plurality of defective circuit images. The general circuit layout of the semiconductor device includes a layout in which a plurality of layer wirings are orthogonal. For example, it is assumed that a certain circuit layout includes a first wiring layer and a second wiring layer. In this case, the first wiring layer can mainly include a wiring extending in a first direction, and the second wiring layer can mainly include a wiring extending in a second direction perpendicular to the first direction. Note that the wiring direction of each of the wiring layers may vary depending on design. For example, it is assumed that the first wiring layer mainly includes the wiring extending in the second direction, and the second wiring layer mainly includes the wiring extending in the first direction. Even in this case, the circuit layout is also established. The classification AI 150 is desirably configured to also detect the defect in either circuit layout described above. Accordingly, the pre-processing unit 301 generates an image resulted from 90-degree rotation of each of the plurality of defective circuit images, and puts the generated image into the defective circuit images. The circuit images are such images that respective wirings in two wiring layers are replaced with each other by the 90-degree rotation. The classification AI 150 learns the original defective circuit image and the image resulted from the 90-degree rotation of the original defective circuit image, and therefore, can classify the normal circuit and the defective circuit, regardless of the respective directions of the two wiring layers.

The image acquisition unit 302 acquires data to be input into the generative AI 130 from the pre-processing unit 301. This data includes at least the plurality of normal circuit images and the plurality of defective circuit images. Also, this data can include the adjustment parameter for adjusting the amount of change of the virtual image from the original image. The adjustment parameter is associated as a coefficient or a weight with each of the circuit images. Alternatively, if the pre-processing of the circuit image is unnecessary, the image acquisition unit 302 may acquire the plurality of normal circuit images and the plurality of defective circuit images as the data to be input into the generative AI 130, from a user's terminal or the like. The image acquisition unit 302 outputs the acquired data to the similarity calculation unit 303.

The similarity calculation unit 303 calculates similarities among the plurality of defective circuit images. The similarities can be respectively defined by differences in feature amount among the defective circuit images. The similarity calculation unit 303 classifies each of the plurality of defective circuit images into a minor defective circuit image or a major defective circuit image based on the feature amount. The major defective circuit image is a defective circuit image that is similar to the other defective circuit image. The minor defective circuit image is a defective circuit image that is not similar to the other defective circuit image. That is, the major defective circuit image is a defective circuit image including a feature to be more frequently detected than the minor defective circuit image.

In an aspect, the similarity calculation unit 303 may output the classification information to the image acquisition unit 302. In this case, to the virtual image acquisition unit 304, the image acquisition unit 302 outputs the plurality of normal circuit images and the plurality of defective circuit images classified. In addition, the image acquisition unit 302 may output the adjustment parameter (the coefficient or the weight for each circuit image) to the virtual image acquisition unit 304. In another aspect, to the virtual image acquisition unit 304, the similarity calculation unit 303 may output the plurality of normal circuit images and the plurality of defective circuit images classified. In this case, the similarity calculation unit 303 may further output the adjustment parameter (the coefficient or the weight for each circuit image) to the virtual image acquisition unit 304. An operation example of the similarity calculation unit 303 using the sample data will be described later with reference to FIG. 6.

The virtual image acquisition unit 304 inputs the various types of acquired data to the generative AI 130, and acquires the virtual images generated by the generative AI 130. The various types of data acquired by the virtual image acquisition unit 304 include the plurality of normal circuit images and the plurality of defective circuit images classified. The various types of data can each further include the adjustment parameter (the coefficient or the weight for each circuit image). To the post-processing unit 305 or the learning processing unit 306, the virtual image acquisition unit 304 outputs the plurality of normal circuit images, the plurality of virtual images including at least a part of the features of the plurality of normal circuit images, the plurality of defective circuit images, and the plurality of virtual images including at least a part of the features of the plurality of defective circuit images. The normal circuit image and the defective circuit image input into the generative AI 130 may also be each referred to as an “original circuit image” below in order to distinguish these images from the generated virtual images.

The number of defective circuit images is possibly smaller than the number of normal circuit images. Accordingly, the virtual image acquisition unit 304 can adjust a parameter as the number of the generated virtual images of the circuit images such that the total number of the normal circuit images and their virtual images is equal to the total number of the defective circuit images and their virtual images.

The virtual image acquisition unit 304 can adjust the parameter as the number of the generated virtual images of the circuit image such that the total number of the minor defective circuit images and their virtual images is equal to the total number of the major defective circuit images and their virtual images. The number of minor defective circuit images is generally smaller than the number of major defective circuit images. Accordingly, if the respective numbers of the generated virtual images of the plurality of defective circuit images are equal, the total number of the major defective circuit images and their virtual images is possibly significantly larger than the total number of the minor defective circuit images and their virtual images. In this case, the classification AI 150 is greatly affected by the major defective circuit images and their virtual images during the learning. As a result, the classification AI 150 may not be able to detect a minor defect even if it can accurately detect a major defect. Accordingly, the virtual image acquisition unit 304 increases the number of the generated virtual images of the minor defective circuit image, to make the total number of the minor defective circuit images and their virtual images equal to the total number of the major defective circuit images and their virtual images. As a result, the classification AI 150 easily detects the minor defect. Further, the virtual image acquisition unit 304 can input the adjustment parameter (the coefficient or the weight for each circuit image) to the generative AI 130.

The post-processing unit 305 can perform an optional processing to the virtual image output by the generative AI 130. The post-processing unit 305 outputs the processed virtual image to the learning processing unit 306. Further, the post-processing unit 305 can also perform an optional processing to the original circuit image. In this case, the post-processing unit 305 outputs the processed original circuit image together with the processed virtual image to the learning processing unit 306.

For example, the post-processing unit 305 can perform gray-out to the virtual image output by the generative AI 130. The virtual image generated by the generative AI 130 may differ in color from the original circuit image. Accordingly, the difference in color between the virtual image and the original circuit image may affect the learning of the classification AI 150. The post-processing unit 305 can prevent the influence of the difference in color between the virtual image and the original circuit image on the classification AI 150 by performing the gray-out to a raw virtual image. The post-processing unit 305 may perform the gray-out to not only the raw virtual image but also the original circuit image.

The learning processing unit 306 inputs the original circuit image and the virtual image acquired from the virtual image acquisition unit 304 or the post-processing unit 305 as the training data into the classification AI 150, and causes the classification AI 150 to perform the learning. After the learning by the classification AI 150 is completed, the learning processing unit 306 outputs a learning completion notification to the evaluation unit 307.

The evaluation unit 307 evaluates the classification AI 150, based on the acquisition of the learning completion notification. For example, the evaluation unit 307 inputs a plurality of circuit images (corresponding to the plurality of test images 160) that have not been used as the training data into the classification AI 150, and causes the classification AI 150 to classify the circuit images. Each of the plurality of circuit images used to evaluate the classification AI 150 is associated with the answer information. The evaluation unit 307 compares the classification result made by the classification AI 150 with the answer information for each of the plurality of circuit images, and calculates the correctness rate in the classification result made by the classification AI 150. If the correctness rate is equal to or more than a predetermined threshold value, the evaluation unit 307 outputs an output permission notification of the classification AI 150 to the output unit 308. If the correctness rate is less than the predetermined threshold value, the evaluation unit 307 outputs a relearning instruction for the classification AI 150 to the learning processing unit 306.

The output unit 308 outputs the classification AI 150 having already learned, based on the acquisition of the output permission notification of the classification AI 150. In an aspect, the output unit 308 may transmit the classification AI 150 body to the user's terminal, based on the reception of the request from the user's terminal. In another aspect, the output unit 308 may provide the classification AI 150 as a service. In this case, the classification AI 150 classifies the circuit image received by the learning support device 300 from the user's terminal, and outputs the classification result to the output unit 308. The output unit 308 transmits the classification result to the user's terminal. Further, in another aspect, the classification AI 150 may be embedded into an application for use as illustrated in FIG. 8. In this case, the learning support device 300 may have a function of the application. Alternatively, another device having the function of the application may use the classification AI 150.

FIG. 4 is a diagram illustrating an example of a hardware configuration of the learning support device 300 according to the present embodiment. The learning support device 300 may not include some of components illustrated in FIG. 4. The learning support device 300 may have a component not illustrated in FIG. 4. Further, the learning support device 300 may have two or more components illustrated in FIG. 4. Each of the functional blocks illustrated in FIG. 3 can be achieved when the program is executed on the hardware illustrated in FIG. 4.

The learning support device 300 includes a processor 401, a memory 402, a storage 403, an external device IF 404, an input IF 405, an output IF 406, and a communication IF 407. In an aspect, the learning support device 300 may include two or more components of them, or may not have some of the components.

The processor 401 can execute a program for achieving various functions of the learning support device 300. The processor 401 is made of, for example, at least one integrated circuit. According to an embodiment, the integrated circuit may include at least one CPU (central processing unit), at least one GPU (graphics processing unit), at least one FPGA (field programmable gate array), at least one ASIC (application specific integrated circuit), at least one AI chip, a combination thereof or the like.

The memory 402 functions as a workspace for the processor 401. The memory 402 stores a program to be executed by the processor 401 and data to be referred to by the processor 401. In an aspect, the memory 402 can be achieved by a DRAM (dynamic random access memory), an SRAM (static random access memory) or the like.

The storage 403 is a nonvolatile memory, and stores a program to be executed by the processor 401 and data to be referred to by the processor 401. The processor 401 executes a program read out from the storage 403 to the memory 402, and refers to data read out from the storage 403 to the memory 402. In an aspect, the storage 403 can be achieved by a HDD (hard disk drive), an SSD (solid state drive), an EPROM (erasable programmable read only memory), an EEPROM (electrically erasable programmable read only memory), a flash memory or the like.

The external device IF 404 can be connected to an optional external device such as a printer, a scanner, and an external HDD. In an aspect, the external device IF 404 can be achieved by a USB (universal serial bus) terminal or the like.

The input IF 405 can be connected to an optional input device such as a keyboard, a mouse, a touch pad, or a game pad. In an aspect, the input IF 405 can be achieved by a USB terminal, a PS/2 terminal, a Bluetooth (registered trademark) module or the like.

The output IF 406 can be connected to an optional output device such as a cathode-ray tube display, a liquid crystal display, or an organic EL display. In an aspect, the output IF 406 can be achieved by a USB terminal, a D-sub terminal, a DVI (digital visual interface) terminal, an HDMI (registered trademark) (high-definition multimedia interface) terminal, a display port terminal or the like.

The communication IF 407 is connected to another device via a wired network or a wireless network. In an aspect, the communication IF 407 can be achieved by a wired LAN (local area network) port, a Wi-Fi (registered trademark) (wireless fidelity) module or the like. In another aspect, the communication IF 407 can transmit and receive data by using a communication protocol such as a TCP/IP (transmission control protocol/Internet protocol) or a UDP (user datagram protocol).

In an aspect, the learning support device 300 is made of single device or a combination of a plurality of devices. The device(s) configuring the learning support device 300 can include a personal computer, a work station, a server device, a tablet, a smartphone, an SoC (system-on-a-chip), and a SoM (system-on-module). The device(s) configuring the learning support device 300 can include an optional peripheral device such as a switch, a router, a display, a keyboard, and a mouse. Further, the learning support device 300 can include a virtual machine and an instance built on a cloud environment. In an aspect, the learning support device 300 may be connected to the input/output device such as the display or the keyboard, and be used as a stand-alone device. In another aspect, the learning support device 300 can provide various functions as a service or a web application via a network. In this case, the user can use the functions of the learning support device 300 via a browser or client software installed in his or her own terminal. Further, the learning support device 300 can also be said to be a learning support system when being made of two or more devices.

As described with reference to FIGS. 1 to 4, the learning support device 300 includes the image acquisition unit 302 that acquires the plurality of defective circuit images 122 representing the circuit layout causing the defect extracted from the existing circuit layout and the plurality of normal circuit images 120 representing the normal circuit layout. The learning support device 300 further includes the virtual image acquisition unit 304 that inputs each of the plurality of defective circuit images 122 into the generative AI 130 and that acquires the plurality of virtual images 142 generated based on the plurality of defective circuit images 122 by the generative AI 130. The learning support device 300 further includes the learning processing unit 306 that inputs the plurality of defective circuit images 122, the plurality of virtual images 142, and the plurality of normal circuit images 120 as the training data into the classification AI 150. The learning support device 300 further includes the output unit 308 that outputs the classification AI 150 having already learned. The learning support device 300 can increase the number of samples of the defective circuit images 122 as training data for the classification AI 150 because of including these components.

In an aspect, the virtual image acquisition unit 304 is configured to generate the plurality of virtual images 142 such that the total number of the plurality of defective circuit images 122 and the plurality of virtual images 142 is equal to the total number of the extracted plurality of normal circuit images 120. In this manner, the learning support device 300 can adjust the number of the defective circuit images to the appropriate number being smaller than that of the normal circuit images.

In an aspect, the virtual image acquisition unit 304 inputs each of the plurality of normal circuit images 120 into the generative AI 130, and acquires the plurality of virtual images 140 generated based on the plurality of normal circuit images 120 by the generative AI 130. The input of the plurality of defective circuit images 122, the plurality of virtual images 140, and the plurality of normal circuit images 120 as the training data into the classification AI 150 includes inclusion of the plurality of virtual images 140 generated based on the plurality of normal circuit images 120 into the training data. In this manner, the learning support device 300 can also adjust the number of the normal circuit images as needed.

In an aspect, each of the plurality of defective circuit images 122 and each of the plurality of normal circuit images 120 includes wirings, the number of which is equal to or more than a predetermined threshold value. In this manner, the learning support device 300 can use a region including a predetermined number or more of wirings as the training data.

In an aspect, the learning support device 300 further includes the pre-processing unit 301 for performing the pre-processing to the existing circuit layout. The pre-processing unit 301 divides the existing circuit layout into sections, sets the first coefficient in the section including the defective part, and sets the second coefficient different from the first coefficient in the section including the normal part. The pre-processing unit 301 is configured to extract the plurality of defective circuit images 122 from the section including the defective part, extract the plurality of normal circuit images 120 from the section including the normal part, and output the plurality of defective circuit images 122 extracted, the plurality of normal circuit images 120 extracted, the first coefficient, and the second coefficient to the image acquisition unit 302. The virtual image acquisition unit 304 inputs the first coefficient and the second coefficient, respectively, as parameters into the generative AI 130. The learning support device 300 can individually adjust the amount of change of the virtual image in the defective circuit image from the original image and the amount of change of the virtual image in the normal circuit image from the original image by putting these coefficients into the parameters of the generative AI 130.

In an aspect, the first coefficient and the second coefficient are the adjustment parameters for adjusting the amount of change of the virtual image generated by the generative AI 130 from the original image. The larger the adjustment parameters are, the larger the difference of the virtual image from the original image is. The pre-processing unit 301 sets a value of the first coefficient to be smaller than a value of the second coefficient. In this manner, regarding the defective circuit images 122, the learning support device 300 can acquire the virtual image more similar to the original image than that of the normal circuit images 120. Regarding the normal circuit images 120, the learning support device 300 can acquire the virtual image having more variation as different from the original image than that of the defective circuit images 122.

In an aspect, setting of the value of the first coefficient to be smaller than the value of the second coefficient includes setting of the value of the first coefficient and the value of the second coefficient such that the value of the first coefficient and the value of the second coefficient are in a predetermined ratio. In this manner, by using the ratio, the learning support device 300 can adjust the respective amounts of change of the virtual images corresponding to the normal circuit images 120 and the defective circuit images 122 from the original circuit images.

In an aspect, the pre-processing unit 301 is configured to generate the plurality of rotation images resulted from the 90-degree rotation of the plurality of defective circuit images 122, and output the plurality of defective circuit images 122 to the image acquisition unit 302 such that the plurality of defective circuit images 122 include the plurality of rotation images. The classification AI 150 can classify the normal circuit and the defective circuit by learning the original defective circuit image and the image resulted from the 90-degree rotation of the original defective circuit image, regardless of the respective directions of two wiring layers.

In an aspect, the learning support device 300 further includes the post-processing unit 305 that performs the gray-out to the plurality of virtual images 142 before the plurality of virtual images 142 are input into the classification AI 150. The post-processing unit 305 can prevent the influence of the difference in color between the virtual image and the original circuit image on the classification AI 150 by performing the gray-out to the raw virtual image.

### B. Classification of Defect and Adjustment of Number of Generated Virtual Images

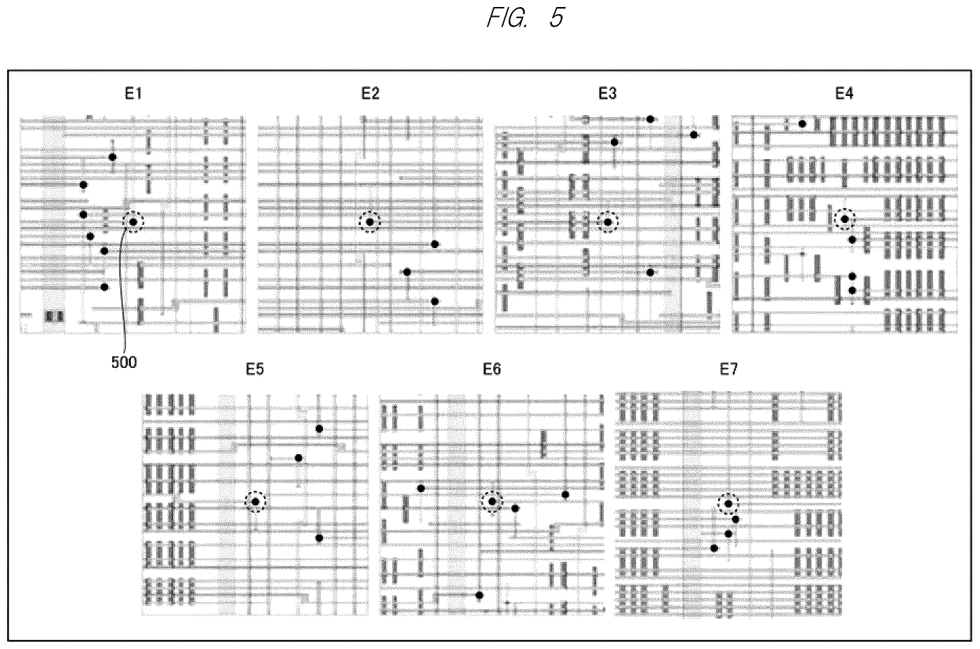

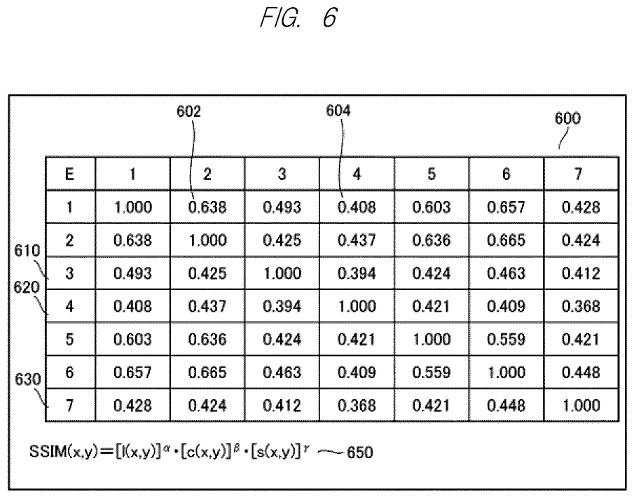

Then, the flow of the learning of the classification AI 150 using a sample circuit image and an experimental result thereof will be described with respect to FIGS. 5 to 7.

FIG. 5 is a diagram illustrating an example of a sample of the circuit image causing the defect. FIG. 5 illustrates seven defective circuit images E1, E2, E3, E4, E5, E6, and E7. Each of the defective circuit images E1 to E7 includes a plurality of orthogonal wirings and a via 500. Each of the defective circuit images E1 to E7 is an image of a circuit in which a manufacturing defect has occurred at the center including the via 500. The defective circuit images E1 to E7 correspond to the plurality of defective circuit images 122 illustrated in FIG. 1. The defective circuit images E1 to E7 and a plurality of virtual images generated from the defective circuit images E1 to E7 are used as the training data for the classification AI 150. In an aspect, the generative AI 130 may generate a set of a plurality of virtual images based on each of defective circuit images. In this case, the set of the plurality of virtual images output by the generative AI 130 corresponds to each defective circuit image (e.g., the defective circuit image E1) input into the generative AI 130. In another aspect, the generative AI 130 may generate a set of a plurality of virtual images based on the plurality of defective circuit images. In this case, the set of the plurality of virtual images output by the generative AI 130 can include one or more features of the plurality of defective circuit images (the defective circuit images E1 to E7) input into the generative AI 130.

FIG. 6 is a diagram illustrating an example of similarities among the detective circuit images E1 to E7 illustrated in FIG. 5. A table 600 shows a calculation result of the similarities among the detective circuit images E1 to E7. For example, the similarities are calculated by an SSIM (structural similarity) equation 650. The similarities may be calculated by another evaluation method.

The similarity is calculated for each set of two defective circuit images. The larger a value of the similarity is, the more similar the two defective circuit images are. For example, a cell 602 shows that the similarity between the defective circuit image E1 and the defective circuit image E2 is “0.638”. A cell 604 shows that the similarity between the defective circuit image E1 and the defective circuit image E4 is “0.408”. A value of the cell 602 is larger than a value of the cell 604. That is, the defective circuit image E1 is more similar to the defective circuit image E2 than to the defective circuit image E4. A cell having a value of “1.000” indicates a similarity between the same defective circuit images.

See the table 600 again. It is found that all values of the respective cells in rows 610, 620, and 630 are smaller than “0.500” except for the similarity between the same defective circuit images and are smaller than the respective values of the cells in other rows. The values of the respective cells in the rows 610, 620, and 630 indicate the similarities between the defective circuit images E3, E4, and E7 and the other defective circuit image. From this point, it is found that the defective circuit images E3, E4, and E7 are not similar to any of the other defective circuit images and are the minor defective circuit images. Accordingly, the learning support device 300 classifies the defective circuit images E3, E4, and E7 to be the minor defective circuit images. The defective circuit images E1, E2, E5, and E6 are similar to the other defective circuit images because of including the cells each having the similarity of “0.500” or larger. Accordingly, the learning support device 300 classifies the defective circuit images E1, E2, E5, and E6 to be the major defective circuit images.

The learning support device 300 adjusts the number of the generated virtual images of each defective circuit image such that the total number of the defective circuit images E1, E2, E5, and E6 and their virtual images is equal to the total number of the defective circuit images E3, E4, and E7 and their virtual images.

As described with reference to FIGS. 5 and 6, the plurality of defective circuit images 122 include the minor defective circuit image and the major defective circuit image. The virtual image acquisition unit 304 is configured to generate the plurality of virtual images 142 including the feature of the minor defective circuit image, the number of which is larger than that of the plurality of virtual images 142 including the feature of the major defective circuit image. In an aspect, the virtual image acquisition unit 304 is configured to generate the plurality of virtual images 142 such that the total number of the plurality of virtual images 142 including the feature of the major defective circuit image is equal to the total number of the plurality of virtual images 142 including the feature of the minor defective circuit image. The learning support device 300 adjusts the respective numbers of the generated virtual images of the minor defective circuit image and the major defective circuit image, thereby easily causing the classification AI 150 having already learned, to detect the minor defective circuit.

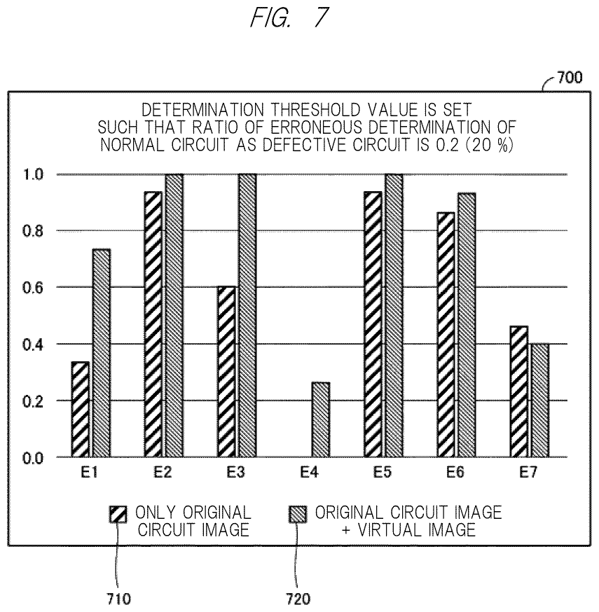

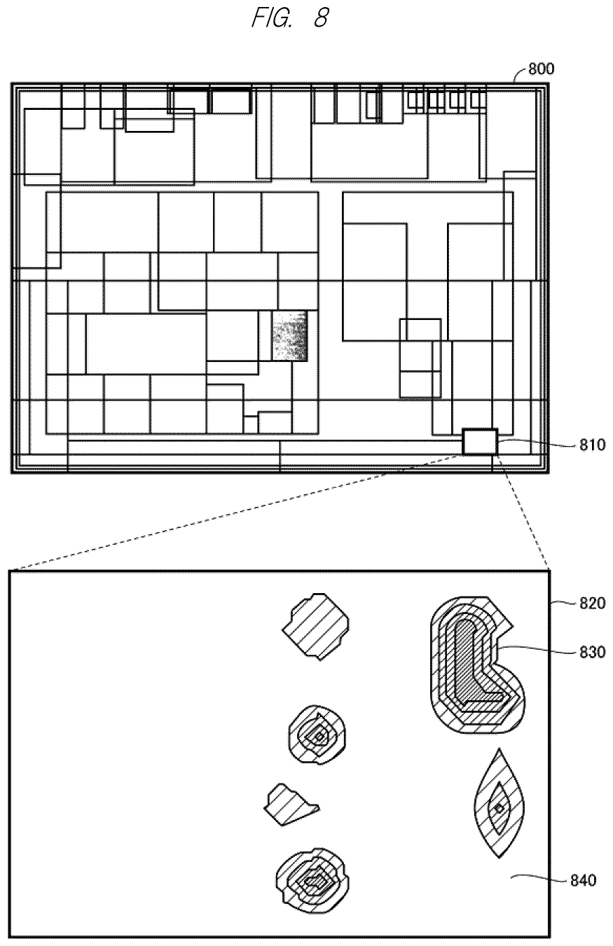

FIG. 7 is a diagram illustrating an example of an experimental result 700 using the defective circuit images illustrated in FIG. 5. The experimental result 700 include a determination result 710 made by the classification AI 150 having already learned, using only the original circuit image as the training data and a determination result 720 made by the classification AI 150 having already learned, using the original circuit image and the virtual image as the training data. A vertical axis of the experimental result 700 represents a detection rate. A horizontal axis of the experimental result 700 represents a type of the defective circuit image.

In an experiment, a threshold value for determining the classification AI 150 is set such that a ratio of erroneous determination of determining the normal circuit as the defective circuit is 0.2 (20%). The test data used for the experiment is an image resulted from shift of a position of the defective part (the via 500) of each of the defective circuit images E1 to E7 from the center.

According to the determination result 710, the classification AI 150 cannot detect the defective circuit image E4 that is the minor defective circuit image at all. This may be because the classification AI 150 is greatly affected by the major defective circuit image during the learning.

On the other hand, according to the determination result 720, the classification AI 150 can detect the defective circuit image E4 that is the minor defective circuit image to some extent. This may be because the increase in the number of virtual images of the defective circuit image E4 included in the training data can cause the classification AI 150 to detect the circuit image similar to the defective circuit image E4.

As described with reference to FIGS. 5 to 7, by the adjustment of the respective numbers of the generated virtual images of the minor defective circuit image and the major defective circuit image, the classification AI 150 having already learned may also easily detect the minor defective circuit.

### C. Use of Classification Result

FIG. 8 is a diagram illustrating an example of an application using the classification AI 150. The classification AI 150 may be configured to output a probability that is a ratio of the defective circuit images over the input circuit images. In this case, for each section of an input circuit image of a semiconductor device 800, the classification AI 150 can output the probability that is the ratio of the defective circuit images over the input circuit images. The application can output a heat map 820 of the semiconductor device 800 by using the probability. The heat map 820 can display a part 830 having a high possibility of the occurrence of the defect to be with a deep color, and display a part 840 having a low possibility of the occurrence of the defect to be with a pale color. Alternatively, the heat map 820 may be illustrated with a contour line. A person in charge of design of the semiconductor device refers to the heat map 820, thereby recognizing the part having the high possibility of the occurrence of the defect on the semiconductor device.

In an aspect, the application may output the heat map 820 of the entire semiconductor device 800. In another aspect, the application may output the heat map 820 of a partial region 810 of the semiconductor device 800. Alternatively, the application can receive a circuit image of the entire semiconductor device 800 and information for specifying the partial region 810 to be illustrated with a heat map. In this case, for each section of the partial region 810, the classification AI 150 can output the probability that is the ratio of the defective circuit images over the input circuit images. The application can output the heat map 820 of the partial region 810 by using the probability.

In an aspect, the learning support device 300 may have a function of the application. In this case, the learning support device 300 may include the application as a heat map generation unit (not illustrated). In this case, the output unit 308 outputs the classification AI 150 having already learned, to a region that can be referred to by the heat map generation unit. The region that can be referred to by the heat map generation unit includes a region in the learning support device 300, a region in a storage of another device, a region on a cloud environment, or any other optional region.

As described with reference to FIG. 8, the classification AI 150 having already learned can be configured to output the probability that is the ratio of the defective circuit images over the input circuit images. The learning support device 300 further includes a heat map generation unit that outputs a heat map of an entire or partial region of a semiconductor device to be tested. The heat map generation unit can input a plurality of input circuit images configuring the entire or partial region of the semiconductor device to be tested, into the classification AI 150 having already learned, and generate the heat map 820 of the entire or partial region of the semiconductor device to be tested, based on the probability of each of the plurality of input circuit images output by the classification AI 150 having already learned. A person in charge of design of the semiconductor device refers to the heat map 820, thereby recognizing the part having the high possibility of the occurrence of the defect on the semiconductor device.

### D. Processing Performed by Learning Support Device

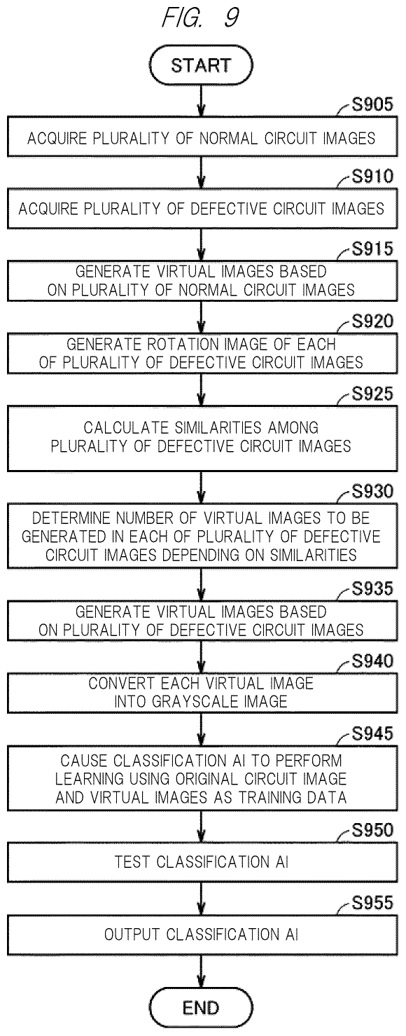

FIG. 9 is a diagram illustrating an example of flow of processing performed by the learning support device 300 according to the present embodiment. In an aspect, the processor 401 may read a program for performing the processing illustrated in FIG. 9 from the storage 403, load the program into the memory 402, and execute the program. In another aspect, the entire or a part of the processing can also be achieved as a combination of circuit elements configured to perform the processing. Further, in another aspect, the following steps may be performed while the order of the steps is rearranged.

In step S905, the learning support device 300 acquires the plurality of normal circuit images. In step S910, the learning support device 300 acquires the plurality of defective circuit images. In an aspect, the learning support device 300 may acquire the design data of the semiconductor device or the circuit image of the entire semiconductor device. In this case, the learning support device 300 can extract the plurality of normal circuit images and the plurality of defective circuit images from the design data or the circuit image of the semiconductor device.

In step S915, the learning support device 300 generates the virtual images based on the plurality of normal circuit images by using the generative AI 130. For example, the generative AI 130 may receive each of the normal circuit images as its input, and generate the plurality of virtual images corresponding to each normal circuit image. For another example, the generative AI 130 may receive the plurality of normal circuit images as its input, and generate the plurality of virtual images from the plurality of normal circuit images.

In step S920, the learning support device 300 generates each rotation image of the plurality of defective circuit images. Each rotation images is an image resulted from the 90-degree rotation of the original defective circuit image. In this and subsequent processes, the learning support device 300 performs each of the processes while putting the plurality of generated rotation images into the plurality of defective circuit images. In an aspect, the learning support device 300 may not perform the process of this step. Alternatively, the learning support device 300 may determine whether or not the process of this step is performed, based on the presence or absence of input of user's instruction to generate the rotation image.

In step S925, the learning support device 300 calculates the similarities among the plurality of defective circuit images. In step S930, the learning support device 300 determines the number of the virtual images to be generated including the feature of the plurality of defective circuit images, based on the similarities. More specifically, the learning support device 300 can determine that a certain circuit and another circuit are similar to each other if the similarity between the certain circuit and another circuit is equal to or more than a predetermined threshold value. The learning support device 300 determines the defective circuit image not similar to any one of the other defective circuit images to be the minor defective circuit image. The learning support device 300 determines the defective circuit image similar to any one of the other defective circuit images to be the major defective circuit image. The learning support device 300 determines the number of the virtual images to be generated in each of the minor defective circuit image and the major defective circuit image such that the total number of the minor defective circuit images and their virtual images is equal to the total number of the major defective circuit images and their virtual images. In an aspect, the learning support device 300 may determine the certain defective circuit image to be the minor defective circuit image if the number of the other defective circuit images similar to the certain defective circuit image is a predetermined number or less. For example, the learning support device 300 determines the certain defective circuit image to be the minor defective circuit image if the number of them similar to the certain defective circuit image is two or less.

In step S935, the learning support device 300 generates the virtual images based on the plurality of defective circuit images by using the generative AI 130. For example, the generative AI 130 may receive each of the defective circuit images as its input, and generate the plurality of virtual images corresponding to each defective circuit image. For another example, the generative AI 130 may receive the plurality of defective circuit images as its input, and generate the plurality of virtual images from the plurality of defective circuit images. The generative AI 130 can generate the virtual images of the circuit images such that the total number of the plurality of normal circuit images and their virtual images is equal to the total number of the plurality of defective circuit images and their virtual images.

In step S940, the learning support device 300 converts each of the generated virtual images into a grayscale image. In an aspect, if the plurality of normal circuit images and the plurality of defective circuit images are not the grayscale images, the learning support device 300 may also convert these circuit images into the grayscale images. In another aspect, the learning support device 300 may convert each of the generated virtual images into an image colored with not the grayscale color but uniform color. Further, in another aspect, the learning support device 300 may not perform the process of this step. Alternatively, the learning support device 300 may determine whether or not the process of this step is performed, based on the presence or absence of input of user's instruction to generate the grayscale image.

In step S945, the learning support device 300 causes the classification AI 150 to perform learning using the original circuit image and the virtual image as the training data. The training data includes the plurality of normal circuit images, the plurality of defective circuit images, and the plurality of virtual images generated based on the plurality of defective circuit images. Further, the training data may include the plurality of virtual images generated based on the plurality of normal circuit images.

In step S950, the learning support device 300 tests the classification AI 150 having already learned. The learning support device 300 causes the classification AI to classify the plurality of circuit images respectively associated with the answers. The learning support device 300 compares the classification result and the answer associated with each of the plurality of circuit images, and tests the classification performance of the classification AI 150. If the correctness rate in the classification AI 150 is equal to or more than the predetermined threshold value, the learning support device 300 outputs the classification AI 150. If the correctness rate in the classification AI 150 is less than the predetermined threshold value, the learning support device 300 causes the classification AI 150 to perform additional learning.

In step S955, the learning support device 300 outputs the classification AI 150 having already learned. In an aspect, the learning support device 300 may transmit the classification AI 150 body to the user's terminal, based on reception of the request from the user's terminal. In another aspect, the learning support device 300 may provide the classification AI 150 as a service.

As described with reference to FIG. 9, the learning support device 300 can be achieved when a computer performs a learning support program for the classification AI 150. The learning support program causes the computer to acquire the plurality of defective circuit images 122 representing the circuit layout causing the defect extracted from the existing circuit layout and to acquire the plurality of normal circuit images 120 representing the normal circuit layout. The learning support program causes the computer to input each of the plurality of defective circuit images 122 to the generative AI 130 and acquire the plurality of virtual images 142 generated based on the plurality of defective circuit images 122 by using the generative AI 130. The learning support device 300 causes the computer to input the plurality of defective circuit images 122, the plurality of virtual images 142, and the plurality of normal circuit images 120 as the training data into the classification AI 150 and to output the classification AI 150 having already learned.

### E. CONCLUSION

As described above, the learning support device 300 according to the present embodiment utilizes the virtual images generated by the generative AI 130 as the training data for the classification AI 150. In this manner, the learning support device 300 can prepare the defective circuit samples, the number of which is sufficient for the learning of the classification AI 150. As a result, the learning support device 300 can enhance the classification accuracy of the classification AI 150 for the circuit image. Further, the learning support device 300 determines the number of virtual images to be generated in each of the minor defective circuit images and the major defective circuit images such that the total number of the minor defective circuit images and their virtual images is equal to the total number of the major defective circuit images and their virtual images. In this manner, the learning support device 300 can increase the ratio of the minor defective circuit images in the training data. As a result, the classification AI 150 can easily detect the minor defect.

In the foregoing, the invention made by the inventors of the present application has been concretely described based on the embodiments. However, it is needless to say that the present invention is not limited to the foregoing embodiments, and various modifications can be made within the scope of the present invention.

What is claimed is:

1. A learning support device comprising:
an image acquisition unit acquiring a plurality of defective circuit images representing a circuit layout causing a defect extracted from an existing circuit layout and a plurality of normal circuit images representing a normal circuit layout;
a virtual image acquisition unit inputting each of the plurality of defective circuit images into a generative AI (artificial intelligence), and acquiring a plurality of virtual images generated based on the plurality of defective circuit images by using the generative AI;
a learning processing unit inputting the plurality of defective circuit images, the plurality of virtual images, and the plurality of normal circuit images as training data into a classification AI; and
an output unit outputting a classification AI having already learned.

2. The learning support device according to claim 1,
wherein the plurality of defective circuit images include a minor defective circuit image and a major defective circuit image, and
the virtual image acquisition unit is configured to generate the plurality of virtual images including a feature of the minor defective circuit image, the number of which is larger than the number of the plurality of virtual images including a feature of the major defective circuit image.

3. The learning support device according to claim 2,
wherein the virtual image acquisition unit is configured to generate the plurality of virtual images such that the total number of the plurality of virtual images including the feature of the major defective circuit image is equal to the total number of the plurality of virtual images including the feature of the minor defective circuit image.

4. The learning support device according to claim 1,
wherein the virtual image acquisition unit is configured to generate the plurality of virtual images such that the total number of the plurality of defective circuit images and the plurality of virtual images is equal to the total number of the plurality of normal circuit images extracted.

5. The learning support device according to claim 1,
wherein the virtual image acquisition unit inputs each of the plurality of normal circuit images to the generative AI, and acquires the plurality of virtual images generated based on the plurality of normal circuit images by using the generative AI, and
input of the plurality of defective circuit images, the plurality of virtual images, and the plurality of normal circuit images as the training data into the classification AI includes inclusion of the plurality of virtual images respectively corresponding to the plurality of normal circuit images into the training data.

6. The learning support device according to claim 1,
wherein each of the plurality of defective circuit images and the plurality of normal circuit images includes wirings, the number of which is equal to or more than a predetermined threshold value.

7. The learning support device according to claim 1, further comprising
a pre-processing unit for performing a pre-processing to the existing circuit layout,
wherein the pre-processing unit is configured to
divide the existing circuit layout into sections,
set a first coefficient for a section including a defective part,
set a second coefficient different from the first coefficient for a section including a normal part,
extract the plurality of defective circuit images from the section including the defective part,
extract the plurality of normal circuit images from the section including the normal part, and
output the plurality of defective circuit images extracted, the plurality of normal circuit images extracted, the first coefficient, and the second coefficient to the image acquisition unit, and
the virtual image acquisition unit inputs the first coefficient and the second coefficient as parameters to the generative AI.

8. The learning support device according to claim 7,
wherein each of the first coefficient and the second coefficient is an adjustment parameter for adjusting an amount of change of a virtual image generated by the generative AI from an original image,
the larger the adjustment parameter is, the larger a difference of the virtual image from the original image is, and
the pre-processing unit sets a value of the first coefficient to be smaller than a value of the second coefficient.

9. The learning support device according to claim 8,
wherein setting of the value of the first coefficient to be smaller than the value of the second coefficient includes setting of the value of the first coefficient and the value of the second coefficient such that the value of the first coefficient and the value of the second coefficient are in a predetermined ratio.

10. The learning support device according to claim 7,
wherein the pre-processing unit is configured to
generate a plurality of rotation images resulted from 90-degree rotation of the plurality of defective circuit images, respectively, and
output the plurality of defective circuit images to the image acquisition unit while including the plurality of rotation images into the plurality of defective circuit images.

11. The learning support device according to claim 1, further comprising
a post-processing unit performing gray-out to the plurality of virtual images before the plurality of virtual images are input into the classification AI.

12. The learning support device according to claim 1 further comprising
a heat map generation unit outputting a heat map of an entire or partial region of a semiconductor device to be tested,
wherein the classification AI having already learned is configured to output a probability that is a ratio of defective circuit images over input circuit images, and
the heat map generation unit is configured to
input a plurality of input circuit images configuring the entire or partial region of the semiconductor device to be tested, into the classification AI having already learned, and
generate the heat map of the entire or partial region of the semiconductor device to be tested, based on the probability of each of the plurality of input circuit images output by the classification AI having already learned.

13. A learning support method for a classification AI, comprising steps of:
acquiring a plurality of defective circuit images representing a circuit layout causing a defect extracted from an existing circuit layout and a plurality of normal circuit images representing a normal circuit layout;
inputting each of the plurality of defective circuit images into a generative AI, and acquiring a plurality of virtual images generated based on the plurality of defective circuit images by using the generative AI;
inputting the plurality of defective circuit images, the plurality of virtual images, and the plurality of normal circuit images as training data into the classification AI; and
outputting a classification AI having already learned.

14. A learning support program for a classification AI executed by a computer, the learning support program causing the computer to:
acquire a plurality of defective circuit images representing a circuit layout causing a defect extracted from an existing circuit layout and a plurality of normal circuit images representing a normal circuit layout;
input each of the plurality of defective circuit images into a generative AI, and acquire a plurality of virtual images generated based on the plurality of defective circuit images by using the generative AI;
input the plurality of defective circuit images, the plurality of virtual images, and the plurality of normal circuit images as training data into the classification AI; and
output the classification AI having already learned.
